(19) United States
(12) Patent Application Publication
(10) Pub. No.: US 2016/0069159 A1
(43) Pub. Date: Mar. 10, 2016

(54) MATRIX-FRACTURE INTERFACE CLEANUP METHOD FOR TIGHT SANDSTONE, CARBONATE, AND SHALE RESERVOIRS

(71) Applicants: Tadesse Weldu Teklu, Golden, CO (US); Najeeb Alharthy, Houston, TX (US); Waleed Salem AlAmeri, Abu Dhabi (AE); Hossein Kazemi, Castle Rock, CO (US); Romana M. Graves, Evergreen, CO (US)

(72) Inventors: Tadesse Weldu Teklu, Golden, CO (US); Najeeb Alharthy, Houston, TX (US); Waleed Salem AlAmeri, Abu Dhabi (AE); Hossein Kazemi, Castle Rock, CO (US); Romana M. Graves, Evergreen, CO (US)

(21) Appl. No.: 14/849,134

(22) Filed: Sep. 9, 2015

Related U.S. Application Data
(60) Provisional application No. 62/048,126, filed on Sep. 9, 2014.

(51) Int. Cl. E21B 37/06; C09K 8/70; E21B 43/16

(52) U.S. Cl. CPC E21B 37/06; E21B 43/16; C09K 8/70

(57) ABSTRACT

The invention is related to a method to clean a matrix-fracture interface of fractured tight sandstone, tight carbonate, and tight shale reservoirs. The method involves the injection of at least one fluid into a reservoir, wherein the fluid is gas, a surfactant, a surfactant solution, or combinations thereof. In some embodiments, the reservoir has previously been stimulated mechanically by hydraulic fracturing.

### CROSS REFERENCE TO RELATED APPLICATIONS

This application claims priority and the benefit under 35 U.S.C. §119(e) to U.S. Provisional Patent Application Ser. No. 62/048,126 filed on Sep. 9, 2014, which is incorporated herein in its entirety by reference.

### FIELD OF THE INVENTION

The invention is related to a method to clean up the matrix-fracture interface.

### BACKGROUND

Without hydraulic fracturing, economic production of hydrocarbon from very low permeability formations is not viable. However, with hydraulic fracturing, the economic hydrocarbon production rate from tight sandstone, carbonate, and shale reservoirs is possible. Nonetheless, production from these tight formation reservoirs declines rapidly in spite of well stimulation. The decline is even faster when fracture surface becomes clogged. This rapid production decline is associated with fracture closing because of pore pressure decline, water blockage, and formation damage caused by precipitation of larger molecular weight hydrocarbon components, gas-condensate dropout, and other production related issues. These problems affect the mass transfer from matrix to fracture.

### SUMMARY

The method discussed herein significantly increases the economic life time and cumulative production of the tight sandstone, carbonate, and shale reservoirs. Tight formation reservoirs in this study is defined when matrix permeability is <1 millidarcy (mD) for oil reservoirs and <0.1 mD for gas reservoirs. With the matrix-fracture cleanup protocol of the present invention, economic hydrocarbon production rate can be prolonged significantly.

The method of the matrix-fracture cleanup is for stimulation purpose. Hence, unlike EOR methods that require intensive capital and man power to properly implement and monitor the improved recovery throughout the production period of the field, this stimulation technique of the present invention is required to implement on a producer well for a short period of time.

The method can be used to clean up the matrix-fracture interface to improve oil and gas production. The method involves a protocol to inject (a) CO₂ followed by surfactant, (b) surfactant followed by CO₂, (c) CO₂ alone, or (d) surfactant solution alone, into tight sandstone or carbonate reservoir producer well. CO₂ and/or surfactants clean up water blocks and larger molecular weight hydrocarbon components precipitated at the interface, and also reduce oil viscosity and interfacial tension (IFT), and alter wettability at the fracture-matrix interface. The same procedure can be applied into injection well to improve injectivity.

Production near or below the saturation pressures in tight sandstone, carbonate, and shale reservoirs could cause precipitation of larger molecular weight hydrocarbon components. This includes gas-condensate dropout. This causes low relative permeability to oil, condensate, and gas. In addition to the issue of precipitation, water blockage, fracture closure, and other effects can also create a situation where mass transfer at the matrix-fracture interface becomes impeded. The proposed cleanup protocol should improve production because of the wettability alteration at the matrix-fracture interface, a reduction of IFT at the matrix-fracture interface, swelling of the oil leading to lower viscosity at the matrix-fracture interface, molecular diffusion, osmotic pressure or counter-current flow induced by gravity head.

Matrix-fracture interface cleanup treatments can improve productivity of single or multi-stage fractured vertical, deviated, or horizontal wells. Many studies show that acid can be used for matrix stimulation in conventional and unconventional reservoirs (Abou-Sayed et al., 2005; McDuff et al., 2010; Morsy et al., 2013; Wu and Sharma, 2015). CO₂ injection can be applied instead of acid stimulation to achieve matrix-fracture interface cleanup. This is because, carbon dioxide can form a weak acid that can clean the matrix-fracture interface and improve production without the use of other stronger acids such as HCl and HF.

A study by EERC (2011) and Yan et al., (2015) shows how the well performance of Bakken wells are improved during three well-completion-design eras. These three well-completion-design eras include: (1) hydraulically fractured vertical wells from 1953 to 1987; (2) horizontal wells after 1987; and (3) multi-stage hydraulic fractured horizontal wells since 2006. The oil production from multi-stage hydraulic fractured horizontal wells usually undergoes a sharp decline in production. To prolong high oil production rate of multi-stage hydraulic fractured horizontal wells, re-fracturing, re-stimulation, matrix-fracture interface cleanup technologies can be employed. This study is mainly concerned with matrix-fracture interface cleanup protocol that can be employed in very tight formations. However, the cleanup method can be used in conjunction with re-fracturing.

An aspect of the invention is a method to enhance production by treating a matrix-fracture interface of a hydrocarbon reservoir. The method includes injecting at least one fluid into the reservoir, wherein the fluid is selected from the group consisting of gas followed by an anionic surfactant, the gas followed by a non-ionic surfactant, the anionic surfactant followed by the gas, the non-ionic surfactant followed by the gas, a miscible gas, a near miscible gas, a low concentration anionic surfactant, and a low concentration non-ionic surfactant. The soaking period after the injection of the fluid is between about 24 hours and about 2 weeks. Production is then initiated from the reservoir.

An aspect of the invention is a method to clean up a matrix fracture interface to improve production from a reservoir. The method includes injecting at least one fluid into the reservoir. The fluid comprises a gas, a surfactant, and combinations thereof. The reservoir has been mechanically stimulated with at least a single stage hydraulic fracture. The soaking period after the injection of the fluid is between about 24 hours and about 2 weeks.

An aspect of the invention is a method to improve the productivity of a hydraulic fractured reservoir. The method includes hydraulically fracturing the hydraulic reservoir and injecting at least one fluid into the reservoir. The fluid comprises a gas, a surfactant, and combinations thereof. The soaking period after the injection of the fluid is between about 24 hours and about 2 weeks.

### BRIEF DESCRIPTION OF THE DRAWINGS

FIG. 1 illustrates a flow diagram of an embodiment of the invention including steps A, B, C and D;

FIG. 2 illustrates a schematic diagram of temperature and pressure controlled piston-cylinder arrangement of an embodiment of the invention;

FIG. 3 illustrates images of pictures of the carbonate and Berea sandstone core slices used for contact angle measurements for three measurement conditions (i, ii, and iii);

FIG. 4 illustrates the contact angle at three measurement conditions for carbonate sandstone and Berea sandstone;

FIG. 5A illustrates the contact angle for carbonate sandstone at measurement condition i;

FIG. 5B illustrates the contact angle for carbonate sandstone at measurement condition ii;

FIG. 5C illustrates the contact angle for carbonate sandstone at measurement condition iii;

FIG. 5D illustrates the contact angle for Berea sandstone at measurement condition i;

FIG. 5E illustrates the contact angle for Berea sandstone at measurement condition ii;

FIG. 5F illustrates the contact angle for Berea sandstone at measurement condition iii;

FIG. 6 illustrates the how the contact angle is measured;

FIG. 7A illustrates the contact angle for crude-aged carbonate cores with oil droplets for seawater without surfactant is used as the surrounding fluid and the carbonate core slice is aged, and the contact angle was measured 133.6 degree;

FIG. 7B illustrates the contact angle for crude-aged carbonate cores with oil droplets for seawater with 1,000 ppm surfactant solution is used as surrounding fluid, and the contact angle between oil droplet and crude-aged carbonate core is measured as 77 degrees;

FIG. 7C illustrates the contact angle for crude-aged carbonate cores with oil droplets for seawater with 1,000 ppm surfactant as surrounding fluid and the contact angle between cleaned un-aged carbonate core slice and oil droplet is measured as 15 degrees.

### DETAILED DESCRIPTION

Fracture closing because of pore pressure decline, water blockage, and formation damage caused by precipitation of larger molecular weight hydrocarbon components, gas-condensate dropout, and other production related issues at the matrix-fracture interface can decrease oil and gas production in tight sandstone, carbonate, and shale reservoirs. The present invention relates to a method to clean up the matrix-fracture interface to improve oil and gas production.

An aspect of the invention is a method to improve hydrocarbon production by treating a matrix-fracture interface of fractured tight formation reservoirs by first injecting into the reservoir at least one fluid selected from the group consisting of gas followed by an anionic surfactant, gas followed by a non-ionic surfactant, an anionic surfactant followed by gas, a non-ionic surfactant followed by gas, a miscible gas, a near miscible gas, a low concentration anionic surfactant, or a low concentration non-ionic surfactant. If necessary, the injection can be repeated or an injection of at least one second material can be used. The second injection can be the same fluid as the first injection, or can be a different fluid selected from the group consisting of gas followed by an anionic surfactant, gas followed by a non-ionic surfactant, an anionic surfactant followed by gas, a non-ionic surfactant followed by gas, a miscible gas, a near miscible gas, a low concentration anionic surfactant, or a low concentration non-ionic surfactant.

The nonionic surfactant can be at least one of ethoxylated alcohol, polyoxyethylene glycol alkyl ether, octaethylene glycol monododecyl ether, pentaethylene glycol monododecyl ether, polyoxypropylene glycol alkyl ether, glucoside alkyl ether, decyl glucoside, lauryl glucoside, octyl glucoside, polyoxyethylene glycol octylphenol ether, triton X-100, polyoxyethylene glycol alkylphenol ether, nonoxynol-9, glycerol alkyl esters, glyceryl laurate, polyoxyethylene glycol sorbitan alkyl esters, polysorbate, sorbitan alkyl esters, spans, cocamide MEA, cocamide DEA, dodecyldimethylamine oxide, block copolymers of polyethylene glycol, polypropylene glycol, similar nonionic surfactants or a poloxamer. The nonionic surfactant can preferably be ethoxylated alcohol. Suitable anionic surfactants include, but are not limited to, surfactants that include sulfonate or a sulfonate group, such as sodium laureth sulfate, ammonium lauryl sulfate, dioctyl sodium sulfosuccinate, perfluorobutanesulfonic acid, perfluorononanoic acid, perfluorooctanesulfonic acid, perfluorooctanoic acid, potassium lauryl sulfate, sodium dodecyl sulfate, sodium dodecyl benzene sulfonate, sodium lauroyl sarcosinate, sodium myreth sulfate, sodium pareth sulfate, sodium stearate, soaps, alkyl sulfate, alkyl ether sulfates, sulfated alkanolamides, glyceride sulfates, dodecyl benzene sulfonate, alpha olefin sulfonates, lignosulfonates, the like and combinations thereof. The concentration of the surfactant, whether non-ionic or anionic, can be between about 500 ppm to about 5,000 ppm.

The gas can be any suitable gas, including but not limited to, carbon dioxide, natural gas liquids, liquid petroleum gas, nitrogen gas, and combinations thereof. The natural gas liquids can be intermediate hydrocarbons, such as ethane to propane (C₂-C₅) gas, and combinations thereof. Liquefied petroleum gas (LPG) can be C₃ (propane) or C₄ (butane) or combinations thereof. Preferably, the gas may be carbon dioxide or NGLs. More preferably, the gas may be carbon dioxide. In some embodiments, at least some of the natural gas liquid or at least some of the LPG may be recycled from the reservoir. One skilled in the art would understand that the recycled natural gas may need to be scrubbed to remove any condensate or water within the gas prior to injection into the reservoir.

The reservoir can include any sandstone, including but not limited to, carbonate or Berea sandstone. In some embodiments, the reservoir is tight carbonate, tight sandstone or tight shale.

The flow rate of the fluid, including the gas, or surfactant, can vary based on permeability, length and number of hydraulic fracture stages, volume of the stimulated area of the reservoir, and other parameters. The soaking period between the injection of the fluids can range from about 24 hours to about 2 weeks based on the tightness of the reservoir. The more “tight” the reservoir, the long soaking period will be required for the injected fluid to effectively clean the matrix-fracture interface. The cycle of matrix-fracture cleanup procedure can be repeated when the hydrocarbon production of a specific well is below economic limit.

Usually tight formation reservoirs are high salinity reservoirs compared to injection water salinity used with the surfactant. Any available water suitable for the surfactant can be used. This includes high salinity water, lower salinity waters, or waters where the salinity level has been adjusted.

An aspect of the invention is a method to clean up the matrix fracture interface to improve oil or gas production in a reservoir. The method includes the injection of at least one fluid into a reservoir, wherein the fluid is gas followed by a surfactant, surfactant followed by a gas, gas alone, or surfactant solution. The reservoir has previously been stimulated mechanically with at least a single stage hydraulic fracture.

While not wanting to be bound by theory, it is believed that the gas, surfactants or combinations of the gas and surfactant either dissolve or remove water blocks and larger molecular weight hydrocarbon components precipitated at the fracture-matrix interface. Furthermore, it is believed that gas and surfactants reduce oil viscosity and interfacial tension and alter wettability at the fracture-matrix interface. Molecular diffusion, osmotic pressure or counter-current imbibition effects can also play a role in the cleaning process.

The reservoir can be one of a tight sandstone reservoir, a tight carbonate reservoir, or a tight shale reservoir. The well can be vertical, deviated or horizontal. Furthermore, the wellbore can be stimulated by single stage or multiple stage hydraulic fracturing.

The surfactant can be nonionic or anionic. The nonionic surfactant can be at least one of ethoxylated alcohol, polyoxyethylene glycol alkyl ether, octaethylene glycol monododecyl ether, pentaethylene glycol monododecyl ether, polyoxypropylene glycol alkyl ether, glucoside alkyl ether, decyl glucoside, lauryl glucoside, octyl glucoside, polyoxyethylene glycol octylphenol ether, triton X-100, polyoxyethylene glycol alkylphenol ether, nonoxynol-9, glycerol alkyl esters, glyceryl laurate, polyoxyethylene glycol sorbitan alkyl esters, polysorbate, sorbitan alkyl esters, spans, cocamide MEA, cocamide DEA, dodecyldimethylamine oxide, block copolymers of polyethylene glycol, polypropylene glycol, similar nonionic surfactants or a poloxamer. The nonionic surfactant can preferably be ethoxylated alcohol. Suitable anionic surfactants include, but are not limited to, surfactants that include sulfonate or a sulfonate group, such as sodium laureth sulfate, ammonium lauryl sulfate, dioctyl sodium sulfosuccinate, perfluorobutanesulfonic acid, perfluorononanoic acid, perfluorooctanesulfonic acid, perfluorooctanoic acid, potassium lauryl sulfate, sodium dodecyl sulfate, sodium dodecyl benzene sulfonate, sodium lauroyl sarcosinate, sodium myreth sulfate, sodium pareth sulfate, sodium stearate, soaps, alkyl sulfate, alkyl ether sulfates, sulfated alkanolamides, glyceride sulfates, dodecyl benzene sulfonate, alpha olefin sulfonates, lignosulfonates, the like and combinations thereof. The concentration of the surfactant, whether non-ionic or anionic, can be between about 500 ppm to about 5,000 ppm.

The gas can be any suitable gas, including but not limited to, carbon dioxide, natural gas liquids, liquid petroleum gas, nitrogen gas, and combinations thereof. The natural gas liquids can be intermediate hydrocarbons, such as ethane to propane (C₂-C₅) gas, and combinations thereof. Liquefied petroleum gas (LPG) can be C₃ (propane) or C₄ (butane) or combinations thereof. Preferably, the gas may be carbon dioxide or NGLs. More preferably, the gas may be carbon dioxide. In some embodiments, at least some of the natural gas liquid or at least some of the LPG may be recycled from the reservoir. One skilled in the art would understand that the recycled natural gas may need to be scrubbed to remove any condensate or water within the gas prior to injection into the reservoir.

The flow rate of the fluid, including the gas, or surfactant, can vary based on permeability, length and number of hydraulic fracture stages, volume of the stimulated area of the reservoir, and other parameters. The soaking period between the injection of the fluids can range from about 24 hours to about 2 weeks based on the tightness of the reservoir. The more “tight” the reservoir, the long soaking period will be required for the injected fluid to effectively clean the matrix-fracture interface. The cycle of matrix-fracture cleanup procedure can be repeated when the hydrocarbon production of a specific well is below economic limit.

Usually tight formation reservoirs are high salinity reservoirs compared to injection water salinity used with the surfactant. Any available water suitable for the surfactant can be used. This includes high salinity water, lower salinity waters, or waters where the salinity level has been adjusted.

An aspect of the invention is a method to improve injectivity in a reservoir. The method involves the injection of at least one fluid into a reservoir, wherein the fluid is gas followed by a surfactant, surfactant followed by a gas, gas alone, or surfactant solution. The reservoir has previously been stimulated mechanically with at least a single stage hydraulic fracture.

The surfactant can be nonionic or anionic. The nonionic surfactant can be at least one of ethoxylated alcohol, polyoxyethylene glycol alkyl ether, octaethylene glycol monododecyl ether, pentaethylene glycol monododecyl ether, polyoxypropylene glycol alkyl ether, glucoside alkyl ether, decyl glucoside, lauryl glucoside, octyl glucoside, polyoxyethylene glycol octylphenol ether, triton X-100, polyoxyethylene glycol alkylphenol ether, nonoxynol-9, glycerol alkyl esters, glyceryl laurate, polyoxyethylene glycol sorbitan alkyl esters, polysorbate, sorbitan alkyl esters, spans, cocamide MEA, cocamide DEA, dodecyldimethylamine oxide, block copolymers of polyethylene glycol, polypropylene glycol, similar nonionic surfactants or a poloxamer. The nonionic surfactant can preferably be ethoxylated alcohol. Suitable anionic surfactants include, but are not limited to, surfactants that include sulfonate or a sulfonate group, such as sodium laureth sulfate, ammonium lauryl sulfate, dioctyl sodium sulfosuccinate, perfluorobutanesulfonic acid, perfluorononanoic acid, perfluorooctanesulfonic acid, perfluorooctanoic acid, potassium lauryl sulfate, sodium dodecyl sulfate, sodium dodecyl benzene sulfonate, sodium lauroyl sarcosinate, sodium myreth sulfate, sodium pareth sulfate, sodium stearate, soaps, alkyl sulfate, alkyl ether sulfates, sulfated alkanolamides, glyceride sulfates, dodecyl benzene sulfonate, alpha olefin sulfonates, lignosulfonates, the like and combinations thereof. The concentration of the surfactant, whether non-ionic or anionic, can be between about 500 ppm to about 5,000 ppm.

The gas can be any suitable gas, including but not limited to, carbon dioxide, natural gas liquids, liquid petroleum gas, nitrogen gas, and combinations thereof. The natural gas liquids can be intermediate hydrocarbons, such as ethane to propane (C₂-C₅) gas, and combinations thereof. Liquefied petroleum gas (LPG) can be C₃ (propane) or C₄ (butane) or combinations thereof. Preferably, the gas may be carbon dioxide or NGLs. More preferably, the gas may be carbon dioxide. In some embodiments, at least some of the natural gas liquid or at least some of the LPG may be recycled from the reservoir. One skilled in the art would understand that the recycled natural gas may need to be scrubbed to remove any condensate or water within the gas prior to injection into the reservoir.

The flow rate of the fluid, including the gas, or surfactant, can vary based on permeability, length and number of hydraulic fracture stages, volume of the stimulated area of the reservoir, and other parameters. The soaking period between the injection of the fluids can range from about 24 hours to about 2 weeks based on the tightness of the reservoir. The more “tight” the reservoir, the long soaking period will be required for the injected fluid to effectively clean the matrix-fracture interface. The cycle of matrix-fracture cleanup procedure can be repeated when the hydrocarbon production of a specific well is below economic limit. Usually tight formation reservoirs are high salinity reservoirs compared to injection water salinity used with the surfactant. Any available water suitable for the surfactant can be used. This includes high salinity water, lower salinity waters, or waters where the salinity level has been adjusted.

The reservoir can be one of a tight sandstone reservoir, a tight carbonate reservoir, or a tight shale reservoir. The well can be vertical, deviated or horizontal. Furthermore, the wellbore can be stimulated by single stage or multiple stage hydraulic fracturing

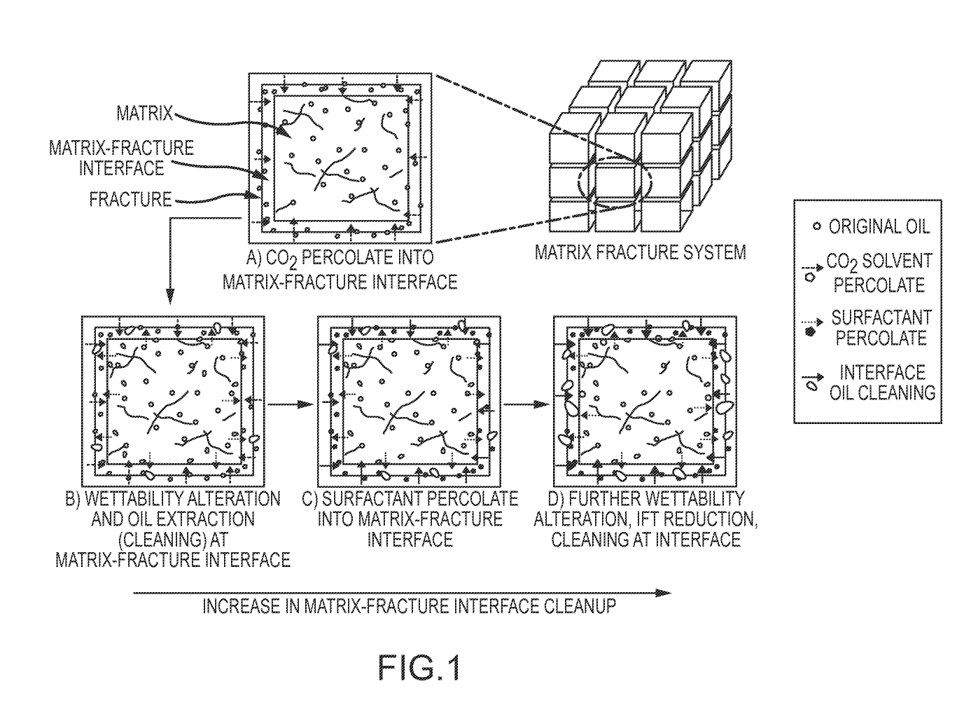

FIG. 1, steps A and B, through convective flow, illustrate that the injected CO₂ will percolate into the limited matrix-fracture interface area. In step A, the gas, in this case carbon dioxide, percolates into the matrix-fracture interface. Step B illustrates the wettability alteration and oil extraction at the matrix-fracture interface. In Step C, surfactant percolates into the matrix-fracture interface. Finally, step D illustrates additional wettability alteration, IFT reduction and cleaning at the interface. As further illustrated in FIG. 1, the matrix fracture interface is cleaned with each step (Steps B to D). After a short duration of time, molecular diffusion will cause the CO₂ to mix with the interface oil, resulting oil swelling, viscosity reduction, IFT reduction, and solvent extraction. These combined effects will lead to cleanup and wettability alteration in the matrix-fracture interface.

Steps C and D of FIG. 1 illustrate that the injected low-concentration anionic/non-ionic surfactant will help wash away (coalesce) oil droplets mobilized by the CO₂ process mentioned above at the matrix-fracture interface. Through advective flow and capillary imbibition suction, the surfactant will percolate further into the limited matrix-fracture interface area. This causes further IFT reduction at the interface. Moreover, surfactant adsorption on the matrix-fracture interface causes further wettability alteration helping overall the cleanup process. Osmotic force due to salinity contrast between injected low-concentration surfactant brine and formation brine at/near the interface can also help the overall cleaning process, if the injected brine salinity is lower than the in-situ brine.

### EXAMPLES

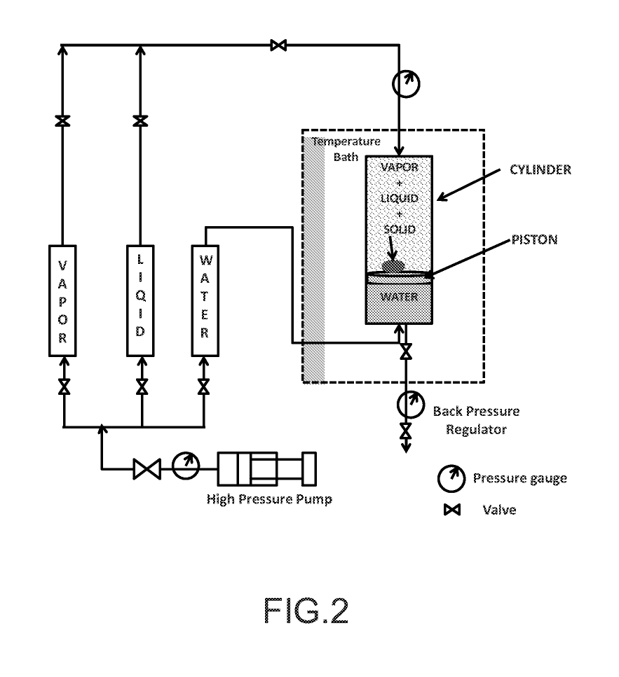

FIG. 2 illustrates a schematic of the temperature and pressure controlled piston-cylinder arrangement to keep the solid-liquid-vapor at specified pressure and temperature until equilibrium state is achieved. The liquid in can be seawater (SW) with and without surfactant; the vapor is a gas, which can be for example CO₂, and the solid is crude aged Carbonate and Berea sandstone core discs or slices. A high pressure pump is used to inject the vapor, the liquid and water into the reservoir. A two day equilibrium time was assumed to be long enough for the SW+gas or SW+Surfactant+gas system to affect the wettability at or above the minimum miscibility pressure. One skilled in the art would understand that the equilibrium time will change with the factors of the system.

Visual observation and contact angle measurements on crude-aged and un-aged core slices of low permeability carbonates and Berea sandstone at different measurement conditions were performed. The carbonate core slices are taken from Middle East reservoir. The carbonate core slices have a permeability of about 1 and porosity of about 21%. Brine-oil interfacial tension (IFT) and brine pH measurements were also performed. Captive oil-droplets contact angle measurement method is used in all wettability measurements. The crude oil and formation brine are also from Middle East reservoir. The crude oil has about 32 API gravity and pH of 6.5. The seawater (SW) used in this experiment has 51,346 ppm salinity and the formation water is about 100,000 ppm salinity.

To study matrix-fracture interface cleanup, three contact angle measurement conditions were applied. Visual observation was also performed in each measurement conditions for any cleaning process. Core slices of carbonate and Berea sandstone were prepared using the measurement conditions.

Measurement Condition i—

Two sets of core slices were prepared and cleaned from the same core plugs, hence have similar characteristics. In the cleaning process of core slices, toluene was applied in Soxhlet extractor until no oil trace was seen, and methanol was used to remove for possible salt presence, again toluene was used to make sure the core slices are clean. One set of carbonate and Berea sandstone core slices were first saturated with formation brine and aged for three weeks in crude oil at reservoir temperature of 195° F. (hereafter crude-aged core slices).

Measurement Condition ii—

Crude-aged core slices where kept for two days in a piston at 2,500 psi in a 300 ml of seawater (SW) and 200 ml of CO₂ mixture, the core slices were then extracted from the piston after the pressure was released slowly, then contact angle measurements between oil-droplets and core slices were performed at room conditions where the surrounding fluid was the SW−CO₂ mixture that was with the core slices in the piston. Note that the SW+CO₂ mixture has less CO₂ concentration as the pressure was released. The minimum miscibility pressure (MMP) of the reservoir crude oil and CO₂ gas was measured using Rising Bubble Apparatus (RBA) at reservoir temperature of 195° F. The MMP is 2,500 psi, hence the 2,500 psi pressure was chosen in this experimental condition to mimic miscible CO₂ flood situation.

Measurement Condition iii—

The core slices are cleaned using the same method discussed in Measurement Condition I (hereafter cleaned un-aged core slice). These samples are used for contact angle measurements where the surrounding fluid was seawater (SW).

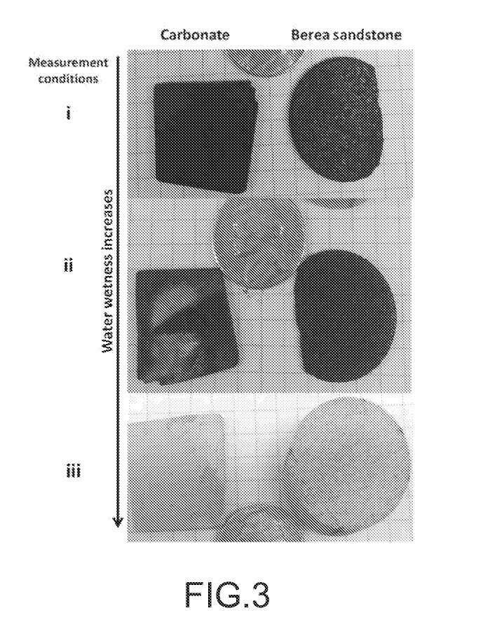

FIG. 3 illustrates images of the core slices corresponding to measurement conditions I (top image), ii (middle image), and iii (bottom image), where the water wetness increases from top to bottom. The circular samples on the right of FIG. 2 are Berea sandstone, while the rectangular samples on the left of FIG. 2 are carbonate sandstone.

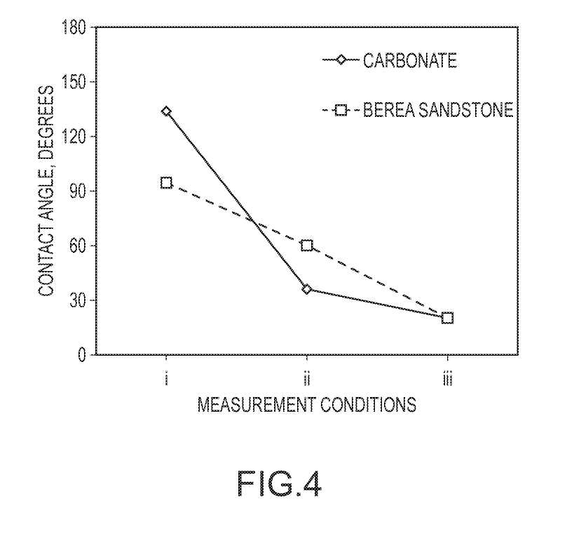

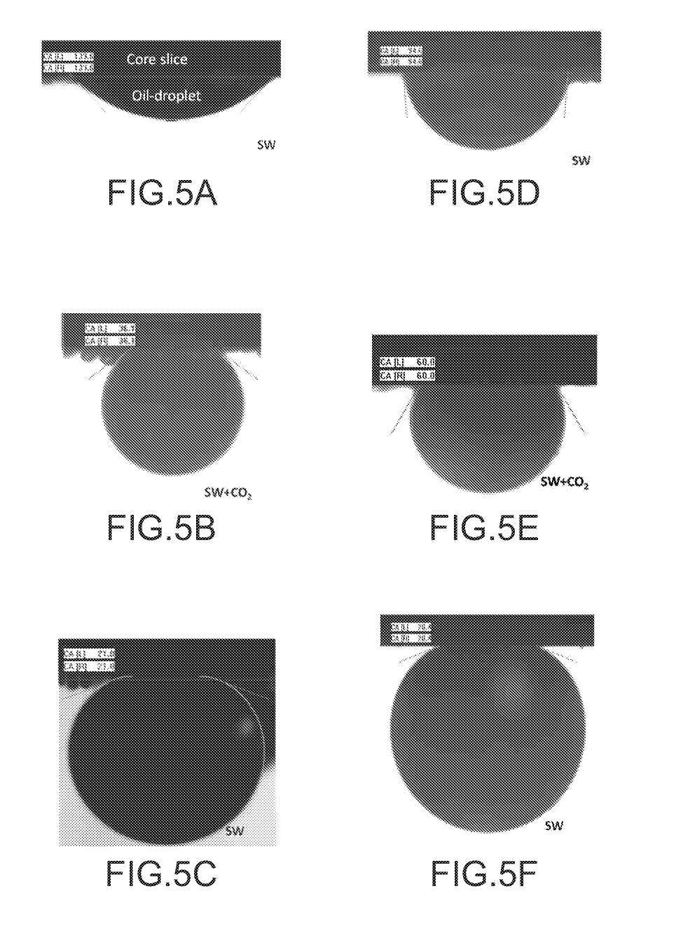

FIGS. 4 and 5A-F, and Table 2 illustrate the contact angle measurement conditions i, ii, and iii for carbonate and Berea sandstone core slices. FIG. 4 illustrates the contact angle between carbonate and Berea sandstone core slices and oil droplet measurements at measurement conditions I, ii, and iii. FIGS. 5A-F illustrate contact angle between carbonate and sandstone core slices and oil-droplet at measurement conditions i, ii, and iii. The contact angle for these figures are shown in Table 1. FIGS. 5A-C illustrate samples that correspond to carbonate core slices, while FIGS. 5D-F illustrate samples that correspond to Berea sandstone core slice. FIGS. 5A and 5D are at measurement condition i. FIGS. 5B and 5E are at measurement condition ii. FIGS. 5C and 5F are at measurement condition iii. The volume of oil droplets for all of the samples illustrated in FIGS. 5A-F range from 4 to 15μ liters. Table 1 illustrates the contact angle between carbonate and Berea sandstone core slices and oil-droplet at measurement conditions i, ii, and iii.

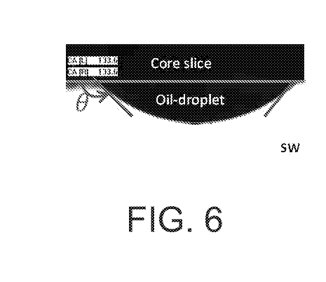

As illustrated in FIGS. 5A-F, the wettability of both carbonate and Berea sandstone constantly changed towards water wet wettability state as the measurement conditions progressed from measurement condition i to iii. This result implies that matrix-fracture interface cleanup can be achieved during the proposed stimulation process of injecting CO₂. FIG. 6 illustrates the how the contact angle is measured. The contact angle, as discussed herein, is measured from the core slice to the angle between a tangential line from the core slice to the oil droplet.

TABLE 1

| | Measurement | Contact Angle Left | Contact Angle Right |
|---|---|---|---|
| FIG. | Condition | (degrees) | (degrees) |
| 5A | i | 133.6 | 133.6 |
| 5B | ii | 36.1 | 36.1 |
| 5C | iii | 21.0 | 21.0 |
| 5D | i | 94.6 | 94.6 |
| 5E | ii | 60.0 | 60.0 |
| 5F | iii | 28.4 | 28.4 |

TABLE 2

| | |
|---|---|
| Contact angle | Contact Angle, Θ, in degrees |

| measurement | | Berea |
|---|---|---|
| condition | Carbonate | Sandstone |
| i | 133.6 | 94.6 |
| ii | 36.1 | 60.0 |
| iii | 21.0 | 20.4 |

From these contact angle measurements and visual observations of oil removal during the process (measurement conditions ii), and also as can be observed in FIG. 3, it can be concluded that CO₂ injection is an effective matrix-fracture interface cleanup stimulation technique in tight sandstone and carbonate reservoirs. This result can also be applied in ultra-low permeability unconventional reservoirs such as the Bakken, Three Forks, and Eagle Fords. The wettability alteration of ultra-low permeability of Three Forks formation during similar experimental procedures is reported in Teklu et al., 2015b, which is incorporated in its entirety by reference.

Additional contact angle measurements were performed on the crude-aged, and cleaned un-aged carbonate cores, where the surrounding fluid is seawater or seawater with 1,000 ppm surfactant solution (SW+Surfactant).

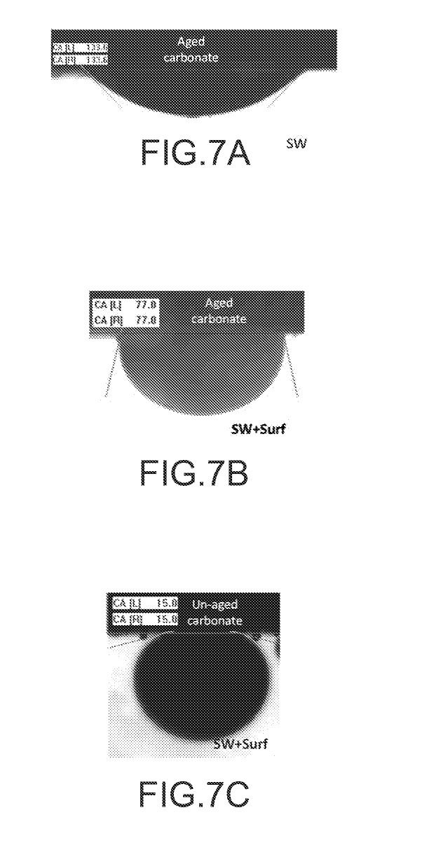

FIG. 7A-C illustrate the contact angle of crude-aged carbonate core with oil droplets. FIG. 7A illustrates seawater without surfactant is used as the surrounding fluid and the carbonate core slice is aged, and the contact angle was measured 133.6 degree (this case is repeated here for comparison reason). FIG. 7B illustrates seawater with 1,000 ppm surfactant solution is used as surrounding fluid, and the contact angle between oil droplet and crude-aged carbonate core is measured as 77 degrees. FIG. 7C illustrates seawater with 1,000 ppm surfactant as surrounding fluid and the contact angle between cleaned un-aged carbonate core slice and oil droplet is measured as 15 degrees. The volume of oil droplets are 3.19, 2.5, and 3.36μ liters for measurements illustrated in FIGS. 7A, B, and C, respectively. Further contact angle and IFT studies with variable salinity and 1,000 ppm surfactant are reported in Alameri et al., (2014). Table 3 illustrates the contact angles illustrated in FIGS. 7A-C.

TABLE 3

| | Contact Angle Left | Contact Angle Right |
|---|---|---|
| FIG. | (degrees) | (degrees) |
| 6A | 133.6 | 133.6 |
| 6B | 77.0 | 77.0 |
| 6C | 15.0 | 15.0 |

Room condition brine pH and oil-brine IFT measurements were also performed where the brine was the SW, SW+CO₂ mixtures, SW and 1,000 ppm surfactant solution (SW+Surfactant), and formation brine. For the case of SW+CO₂ brine mixture, most of the CO₂ were escaped from the solution since the measurement was performed at atmospheric pressure. As illustrated in Table 4, at atmospheric pressure and room temperature, a moderate IFT and pH reduction due to CO₂ solution in the mixture was observed as compared to the SW. Further IFT and pH reduction is anticipated at reservoir pressure since the CO₂ concentration increases similar to the observations reported in study by Yang et al., (2005). An order of magnitude reduction in IFT was observed when 1,000 ppm surfactant solution is used; and with proper surfactant formulation, ultra-low IFT surfactant that can reduce the IFT by two or three order of magnitude may be used in the cleanup process.

TABLE 4

| | IFT between | |
|---|---|---|
| | oil and brine, | |
| Brine | dynes/cm | pH |
| SW | 16.62 | 6.60 |
| SW + CO₂ mixture | 11.96 | 5.50 |
| SW + Surfactant | 4.14 | 7.94 |
| Formation Brine | 8.26 | 7.17 |
| oil | NA | 6.50 |

Based on the experimental observation and theoretical concepts:
Soaking a stimulated reservoir volume of tight and ultra-tight reservoirs using injection of: (a) CO₂ followed by surfactant; (b) surfactant followed by CO₂; (c) miscible or near miscible CO₂ gas; or (d) surfactant—can improve oil recovery through production increment attributed to matrix-fracture interface cleanup.
The wettability alteration due to SW+CO₂ or SW+CO₂+Surfactant soaking (measurement conditions ii) are significant. This shows that the proposed matrix-fracture cleanup protocol can be applied in tight and ultra-tight formations to improve oil recovery.
It is theorized that as the injection volume of CO₂/surfactant/both fluid increases, the effectiveness of matrix-fracture cleanup process increases. However, further experiments are needed to assess this conclusion.
The maximum achievable matrix-fracture interface cleanup with the proposed process is where the interface is close to the ‘cleaned and un-aged’ core slice contact angle measurement conditions.

Ranges are set forth in the Specification. One skilled in the art would understand that any sub-range within the ranges or any particular value within the range would be suitable for use.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiment described hereinabove is further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

1. A method to enhance production by treating a matrix-fracture interface of a hydrocarbon reservoir, comprising:
injecting at least one fluid into the reservoir, wherein the at least one fluid is selected from the group consisting of:
gas followed by an anionic surfactant;
the gas followed by a non-ionic surfactant;
the anionic surfactant followed by the gas;
the non-ionic surfactant followed by the gas;
a miscible gas;
a near miscible gas;
a low concentration anionic surfactant; and
a low concentration non-ionic surfactant;
wherein a soaking period after the injection of the at least one fluid is between about 24 hours and about 2 weeks; and
initiating production of the reservoir.

2. The method of claim 1, further comprising a second injection of a second fluid, wherein the second fluid of the second injection is selected from the group consisting of:
the gas followed by an anionic surfactant;
the gas followed by a non-ionic surfactant;
the anionic surfactant followed by the gas;
the non-ionic surfactant followed by the gas;
a miscible gas;
a near miscible gas;
a low concentration anionic surfactant; and
a low concentration non-ionic surfactant.
wherein a soaking period after the second injection of the second fluid is between about 24 hours and about 2 weeks.

3. The method of claim 1, wherein the concentration of the low concentration anionic surfactant is between 500 ppm to about 5,000 ppm.

4. The method of claim 1, wherein the concentration of the low concentration non-ionic surfactant is between 500 ppm to about 5,000 ppm.

5. The method of claim 1, wherein the gas is carbon dioxide.

6. The method of claim 1, wherein the anionic surfactant is surfactants that include sulfonate or a sulfonate group.

7. The method of claim 1, wherein the anionic surfactant is a sodium laureth sulfate, an ammonium lauryl sulfate, a dioctyl sodium sulfosuccinate, a perfluorobutanesulfonic acid, a perfluorononanoic acid, a perfluorooctanesulfonic acid, a perfluorooctanoic acid, a potassium lauryl sulfate, a sodium dodecyl sulfate, a sodium dodecyl benzene sulfonate, a sodium lauroyl sarcosinate, a sodium myreth sulfate, a sodium pareth sulfate, a sodium stearate, a soap, an alkyl sulfate, an alkyl ether sulfate, a sulfated alkanolamide, glyceride sulfates, a dodecyl benzene sulfonate, an alpha olefin sulfonate, a lignosulfonate, and combinations thereof.

8. The method of claim 1, wherein the non-ionic surfactant is an ethoxylated alcohol, a polyoxyethylene glycol alkyl ether, an octaethylene glycol monododecyl ether, a pentaethylene glycol monododecyl ether, a polyoxypropylene glycol alkyl ether, a glucoside alkyl ether, a decyl glucoside, a lauryl glucoside, an octyl glucoside, a polyoxyethylene glycol octylphenol ether, a triton X-100, a polyoxyethylene glycol alkylphenol ether, a nonoxynol-9, a glycerol alkyl ester, a glyceryl laurate, a polyoxyethylene glycol sorbitan alkyl ester, a polysorbate, a sorbitan alkyl ester, a cocamide MEA, a cocamide DEA, a dodecyldimethylamine oxide, a block copolymer of polyethylene glycol, a polypropylene glycol, a poloxamer and combinations thereof.

9. A method to clean up a matrix fracture interface to improve production in a reservoir, comprising:
injecting at least one fluid into the reservoir, wherein the at least one fluid comprises a gas, a surfactant, and combinations thereof, wherein the reservoir has been mechanically stimulated with at least a single stage hydraulic fracture, and wherein a soaking period after the injection of the at least one fluid is between about 24 hours and about 2 weeks.

10. The method of claim 9, further comprising a second injection of a second fluid, wherein the second fluid of the second injection is selected from the group consisting of:
the gas followed by an anionic surfactant;
the gas followed by a non-ionic surfactant;
the anionic surfactant followed by the gas;
the non-ionic surfactant followed by the gas;
a miscible gas;
a near miscible gas;
a low concentration anionic surfactant; and
a low concentration non-ionic surfactant,
wherein a soaking period after the second injection of the second fluid is between about 24 hours and about 2 weeks.

11. The method of claim 9, wherein the concentration of the low concentration anionic surfactant is between 500 ppm to about 5,000 ppm.

12. The method of claim 9, wherein the concentration of the low concentration non-ionic surfactant is between 500 ppm to about 5,000 ppm.

13. The method of claim 9, wherein the gas is carbon dioxide.

14. The method of claim 9, wherein the anionic surfactant is surfactants that include sulfonate or a sulfonate group.

15. The method of claim 9, wherein the anionic surfactant is a sodium laureth sulfate, an ammonium lauryl sulfate, a dioctyl sodium sulfosuccinate, a perfluorobutanesulfonic acid, a perfluorononanoic acid, a perfluorooctanesulfonic acid, a perfluorooctanoic acid, a potassium lauryl sulfate, a sodium dodecyl sulfate, a sodium dodecyl benzene sulfonate, a sodium lauroyl sarcosinate, a sodium myreth sulfate, a sodium pareth sulfate, a sodium stearate, a soap, an alkyl sulfate, an alkyl ether sulfate, a sulfated alkanolamide, glyceride sulfates, a dodecyl benzene sulfonate, an alpha olefin sulfonate, a lignosulfonate, and combinations thereof.

16. The method of claim 9, wherein the non-ionic surfactant is an ethoxylated alcohol, a polyoxyethylene glycol alkyl ether, an octaethylene glycol monododecyl ether, a pentaethylene glycol monododecyl ether, a polyoxypropylene glycol alkyl ether, a glucoside alkyl ether, a decyl glucoside, a lauryl glucoside, an octyl glucoside, a polyoxyethylene glycol octylphenol ether, a triton X-100, a polyoxyethylene glycol alkylphenol ether, a nonoxynol-9, a glycerol alkyl ester, a glyceryl laurate, a polyoxyethylene glycol sorbitan alkyl ester, a polysorbate, a sorbitan alkyl ester, a cocamide MEA, a cocamide DEA, a dodecyldimethylamine oxide, a block copolymer of polyethylene glycol, a polypropylene glycol, a poloxamer and combinations thereof.

17. A method to improve the productivity of a hydraulic reservoir, comprising:
hydraulically fracturing the hydraulic reservoir; and
injecting at least one fluid into the reservoir, wherein the at least one fluid comprises a gas, a surfactant, and combinations thereof, wherein a soaking period after the injection of the at least one fluid is between about 24 hours and about 2 weeks.

18. The method of claim 17, wherein the gas is carbon dioxide.

19. The method of claim 17, wherein the surfactant is anionic selected from the group consisting of a sodium laureth sulfate, an ammonium lauryl sulfate, a dioctyl sodium sulfosuccinate, a perfluorobutanesulfonic acid, a perfluorononanoic acid, a perfluorooctanesulfonic acid, a perfluorooctanoic acid, a potassium lauryl sulfate, a sodium dodecyl sulfate, a sodium dodecyl benzene sulfonate, a sodium lauroyl sarcosinate, a sodium myreth sulfate, a sodium pareth sulfate, a sodium stearate, a soap, an alkyl sulfate, an alkyl ether sulfate, a sulfated alkanolamide, glyceride sulfates, a dodecyl benzene sulfonate, an alpha olefin sulfonate, a lignosulfonate, and combinations thereof.

20. The method of claim 17, wherein the non-ionic surfactant is an ethoxylated alcohol, a polyoxyethylene glycol alkyl ether, an octaethylene glycol monododecyl ether, a pentaethylene glycol monododecyl ether, a polyoxypropylene glycol alkyl ether, a glucoside alkyl ether, a decyl glucoside, a lauryl glucoside, an octyl glucoside, a polyoxyethylene glycol octylphenol ether, a triton X-100, a polyoxyethylene glycol alkylphenol ether, a nonoxynol-9, a glycerol alkyl ester, a glyceryl laurate, a polyoxyethylene glycol sorbitan alkyl ester, a polysorbate, a sorbitan alkyl ester, a cocamide MEA, a cocamide DEA, a dodecyldimethylamine oxide, a block copolymer of polyethylene glycol, a polypropylene glycol, a poloxamer and combinations thereof.
